(19) United States
(12) Patent Application Publication
(10) Pub. No.: US 2026/0295620 A1
(43) Pub. Date: Oct. 1, 2026

(54) COATING METHOD AND ASSOCIATED COATING INSTALLATION

(71) Applicant: Dürr Systems AG, Bietigheim-Bissingen (DE)

(72) Inventors: Hans-Georg Fritz, Ostfildern (DE); Benjamin Wöhr, Güglingen (DE); Jerome Lavallée, Stuttgart (DE); Moritz Bubek, Ludwigsburg (DE); Timo Beyl, Besigheim (DE); Daniel Tandler, Stuttgart (DE); Tobias Berndt, Ditzingen (DE); Peter Haller, Herrenberg (DE); Markus Hauber, Stuttgart (DE); Frank Herre, Oberriexingen (DE); Harald Kunz, Bruchsal (DE); Julian Ricardo Diaz Posada, Kornwestheim (DE); Alexander Spiller, Korntal-Münchingen (DE)

(21) Appl. No.: 19/479,525

(22) PCT Filed: Apr. 1, 2024
(86) PCT No.: PCT/EP2024/058824

§ 371 Date: Oct. 28, 2025

(30) Foreign Application Priority Data
Apr. 28, 2023 (DE) 10 2023 111 130.2

(51) Int. Cl. B05B 12/16

(52) U.S. Cl. CPC B05B 12/16

(57) ABSTRACT

A coating method for coating a component (e.g. motor vehicle body component) with a coating agent (e.g. paint), including application of the coating agent to the component along a reference track within a coating area on the component, detection of the spatial course of the reference track applied to the component, determining the spatial course of at least one neighboring track adjacent to the reference track depending on the determined spatial course of the reference track, application of the coating agent to the component along the at least one neighboring track within the coating area on the component, and determination of defects on the component, in particular under the reference track, in order to avoid incorrect detection of the spatial course of the reference track and a correspondingly incorrect determination of the spatial course of the at least one neighboring track.

### CROSS-REFERENCE TO RELATED APPLICATIONS:

This application is a national stage of, and claims priority to, Patent Cooperation Treaty Application No. PCT/EP2024/058824, filed on Apr. 1, 2024, which application claims priority to German Application No. DE 10 2023 111 130.2, filed on Apr. 28, 2023, which applications are hereby incorporated herein by reference in their entireties.

### TECHNICAL FIELD

The disclosure relates to a coating method for coating a component (e.g. motor vehicle body components) with a coating agent (e.g. paint). The disclosure also relates to a corresponding coating installation.

### BACKGROUND

When painting vehicle body components, a check for paint defects is usually carried out after the paint has been applied, whereby such paint defects may be sanded off, resulting in annoying sanding marks in the freshly painted component surface. In many cases, such sanding marks can be removed by polishing, resulting in a flawless overall impression.

If the vehicle body component is painted over in a subsequent process, polishing can be dispensed with. This subsequent painting process can be carried out using an overspray-free applicator or print head, for example. For the sake of simplicity, the term print head is used below. It includes all applicators that apply coating agents without loss (i.e. without overspray).

In a known process, a painting robot paints a reference track on this component surface. The spatial course of the reference track is then recorded by an optical sensor (e.g. camera system) by measuring the longitudinal edge of the reference track. A further coating track can then be applied next to the reference track, which is adjacent to the reference track and positioned according to the previous measurement of the reference track, as is known, for example, from DE 10 2021 108 563 A1. When the reference track is applied to a flawless paint layer without annoying sanding points, the optical sensor can usually measure the reference track well. However, if the sensor observes a sanding point in the paint layer, the sensor may no longer be able to accurately detect the course of the reference track, as the sanding point has different optical properties than the paint layer underneath. There is therefore a risk that the reference track cannot be measured accurately due to the annoying sanding points.

With regard to the technical background, reference should also be made to DE 10 2021 206 386 A1 and DE 10 2017 005 170 A1.

### BRIEF DESCRIPTION OF THE DRAWINGS

FIG. 1 shows a schematic representation of a painting installation according to the disclosed technology for painting a motor vehicle body component with two cooperating painting robots.

FIG. 2 shows the painting installation as shown in FIG. 1, with a measuring track also shown, along which the spatial course of the reference track is measured.

FIG. 3 shows the representation shown in FIGS. 1 and 2, with numerous parallel coating strips applied to the component surface.

FIG. 4 shows a flow chart to illustrate the coating method according to the disclosure.

FIG. 5 shows a diagram explaining the various possible countermeasures for detecting defects along the reference track.

FIG. 6 shows a schematic representation of a painting installation according to the disclosure with various stations.

FIG. 7 shows a modification of FIG. 6.

### DETAILED DESCRIPTION

The disclosure is based on the task of solving the above-described problem of measuring the reference track when defects (e.g. sanding points) make measurement difficult.

This task is solved by a coating method according to the disclosure or by a corresponding coating installation according to the independent claims.

The term “defect” used in the context of the disclosure is to be understood generally and is not limited to the sanding points mentioned above as examples. Defects can be defined by disturbances such as foreign particles, paint accumulations or craters or dents in the paint film. To remove these, they are sanded manually or automatically in the subsequent process. This creates sanding points in their place, which are usually larger than the original defects. The term defect includes the term sanding point.

The coating method according to the disclosure is generally suitable for applying a coating agent to a component. The coating agent applied can be paint, while the coated component can be a motor vehicle body component. However, the disclosure is not limited to motor vehicle body components or paints with regard to the type of coated component and also with regard to the coating agent applied.

In accordance with the prior art, the coating method according to the disclosure initially provides for the coating agent (e.g. paint) to be applied along a reference track within a coating area on the component to be coated (e.g. motor vehicle body component). Such an application of a reference track is also known, for example, from DE 10 2021 108 563 A1, whereby the reference track can also be referred to as a “master track” and serves as a positioning aid for subsequent parallel coating tracks (neighboring tracks), which are applied next to the reference track.

Furthermore, in accordance with the prior art, the coating method according to the disclosure provides for the spatial course of the reference track applied to the component to be detected. In an embodiment of the disclosure, this detection of the spatial course of the reference track is carried out by at least one optical sensor, such as a camera system, as will be described in detail.

In a further step, the coating method according to the disclosure then also provides, in accordance with the prior art, that the spatial course of at least one neighboring track adjacent to the reference track is determined depending on the determined spatial course of the reference track, as is also known from DE 10 2021 108 563 A1. The neighboring track is therefore placed next to the reference track in such a way that the reference track and the neighboring track overlap to form a continuous coating agent layer, with no gaps or overcoatings occurring if possible. It should be mentioned here that in practice not only a single neighboring track is applied. Rather, numerous parallel coating agent tracks are applied, which then form a continuous coating agent layer on the component to be coated. The position and alignment of the individual coating tracks can be based on the original reference track. Alternatively, however, it is also possible for the first neighboring track to form a new reference track for the application of the subsequent coating agent tracks, so that the neighboring track is then first optically measured as the new reference track.

In accordance with the prior art (e.g. DE 10 2021 108 563 A1), the coating method according to the disclosure then provides for the coating agent to be applied to the component along the neighboring track. It should again be mentioned here that in practice not only a single neighboring track is applied. Rather-as already briefly mentioned above-numerous coating agent tracks are applied parallel to the original reference track, whereby the individual coating agent tracks then together form a continuous coating on the component.

The coating method according to the disclosure is now characterized in comparison with the prior art by the fact that the annoying defects (e.g. sanding points) on the component described at the beginning are determined in order to avoid incorrect detection of the spatial course of the reference track, since such an incorrect measurement of the spatial course of the reference track would also lead to a correspondingly incorrect determination of the spatial course of the at least one neighboring track. It should be mentioned here that not all defects on the component are critical for the detection of the course of the reference track. Rather, the detection of the spatial course of the reference track is disturbed in particular by those defects that lie directly below the reference track or are adjacent to the reference track.

When detecting critical defects (e.g. sanding points) on the component, various measures are then possible to solve the problem of detecting the spatial course of the reference track.

One measure can be to interpolate the spatial course of the reference track in the area of the defects along the reference track. If the exact course of the reference track cannot be measured due to defects (e.g. sanding points), this course can be interpolated accordingly.

Another measure includes measuring numerous measuring points along the reference track, whereby only those measuring points are taken into account that lie outside the defects.

Another measure is that the reference track is not used at all to position the neighboring tracks if the exact course of the reference track cannot be measured with sufficient accuracy due to the defects (e.g. sanding points). In this case, another coating track can be used as a reference track.

It should also be mentioned that, within the scope of the disclosure, it is possible for the coating area (e.g. a roof of a motor vehicle body) to be divided into two partial areas (e.g. left half of the roof and right half of the roof), with the two partial areas then each being coated by a coating robot. This cooperation between two coating robots is also known, for example, from DE 10 2021 108 563 A1.

The first coating robot then normally coats the first partial area (e.g. left half of the roof) of the coating area (e.g. roof of a vehicle body), while the second coating robot coats the second partial area (e.g. right half of the roof) of the coating area (e.g. roof of the vehicle body), provided that no critical defects are detected along the reference track.

If, on the other hand, annoying critical defects are detected along the reference track and the course of the reference track cannot therefore be determined with sufficient accuracy, it is possible as a problem-solving measure that the second partial area (e.g. right half of the roof) of the coating area (e.g. roof of the vehicle body) is also coated by the first coating robot, so that the complete coating area (e.g. roof of the vehicle body) is coated by the first coating robot. In this case, the performance of the painting installation is halved and the cycle time is extended accordingly, but this is still better than a complete failure of the painting installation.

Various problem-solving measures have been described above, which can be implemented alone or together. However, there is also the alternative option of stopping the coating method if defects are detected along the reference track.

However, the coating method should only be discontinued if at least one of the following conditions is also met:

The number of defects on the reference track exceeds a certain maximum value, so that the course of the reference track cannot be determined with sufficient accuracy.

The size of the defects on the reference track exceeds a certain maximum size, so that the course of the reference track cannot be determined with sufficient accuracy.

The spatial position of the defects along the reference track is critical. For example, defects far from the reference track are less critical for the accuracy of the measurement of the reference track, whereas defects close to the reference track or below the reference track are more problematic.

In general, it should be mentioned that the spatial position of the defects on the component is determined when determining the defects along the reference track. In addition, the size of the defects is also determined. Here it is possible that only those defects are taken into account that have at least a certain minimum size (i.e. spatial extent), for example a minimum size of at least 20 mm, 50 mm or 100 mm.

It has already been explained at the beginning with regard to the prior art that the defects are usually sanding points that occur when paint defects in a previously applied paint layer are repaired. Prior to the method according to the disclosure described above, a paint layer is therefore first applied to the component, whereby the paint defects in the applied paint layer are then determined. The paint defects can then be sanded off, resulting in the aforementioned sanding points, which then hinder the measurement of the spatial course of the reference track.

When sanding the component surface as described above, the spatial position of the sanding points on the component can be determined directly. It may then no longer be necessary to subsequently optically measure the spatial location and position of the sanding points. Instead, the spatial position of the sanding points on the component can then be stored so that the stored spatial positions of the sanding points can simply be read out to determine the spatial position of the defects along the reference track.

The position of the sanding points can also be read from a higher-level, automatic defect inspection or detection system, whereby in a particular variant of the disclosure, defects in the paint layer are sanded by a robot-guided sanding system, so that the size and position of the sanding points are known very precisely.

It has already been mentioned above that an image processing system with an optical sensor (e.g. camera) can be used to detect the spatial course of the reference track applied to the component and the defects.

In one variant of the disclosure, the optical sensor (e.g. camera) is attached to one of the coating robots and is moved over the component by the coating robot.

In another variant of the disclosure, however, the optical sensor (e.g. camera) is arranged in a fixed position and aligned towards the coating area. In this case, the fixed optical sensor can be part of a higher-level surface inspection or defect detection system, which is already present.

It should also be mentioned that the reference track is applied by a first coating robot, while the at least one neighboring track is applied by a second coating robot. The optical sensor can be attached to the first coating robot and/or to the second coating robot and can be moved by it over the surface of the component to be coated.

The optical sensor can be moved along a measuring track over the surface of the component to be coated in order to detect the spatial course of the reference track. The measuring track can run alongside the reference track and essentially parallel to the reference track.

It has already been explained above that the exact positioning of the at least one neighboring track relative to the reference track is important so that the reference track and the neighboring track overlap and form a continuous coating agent layer, whereby gaps or undercoatings on the one hand and overcoatings on the other should be avoided.

This is relatively simple if an atomizer is used as the application device, which applies a spray jet of the coating agent and has low separation precision. The low separation precision of the coating agent jet applied by the atomizer offers the advantage that positioning errors are tolerated and only lead to minor and hardly disturbing overcoatings or undercoatings between the adjacent coating agent tracks.

Alternatively, however, it is also possible to use an overspray-free applicator or print head as the application device, which does not apply a spatially extended and less sharp spray jet, but a narrowly defined and sharp coating agent jet. The problem with the use of such an overspray-free print head is the fact that the positioning of the neighboring track relative to the reference track must be much more precise in order to avoid overcoating and undercoating. The disclosure is therefore particularly advantageous when using such an overspray-free print head, because disruptive positioning errors caused by incorrect measurement of the spatial course of the reference track are avoided.

In addition to the coating method according to the disclosure described above, the disclosure also claims protection for a corresponding coating installation.

In accordance with the prior art (e.g. DE 10 2021 108 563 A1), the coating installation according to the disclosure initially comprises a first coating robot in order to apply the coating agent (e.g. paint) along the reference track within a coating area (e.g. roof of a motor vehicle body) to the component (e.g. motor vehicle body).

In addition, the coating installation according to the disclosure also has at least one optical sensor (e.g. camera) in accordance with the prior art (e.g. DE 10 2021 108 563 A1) in order to detect the spatial course of the reference track applied to the component.

It is possible for the first coating robot to apply the reference track and for the optical sensor to be attached to the second coating robot and record the spatial course of the reference track.

The coating installation according to the disclosure also comprises a control device for interrogating the optical sensor and determining the spatial course of a neighboring track adjacent to the reference track depending on the determined spatial course of the reference track.

The control device contains a program memory with a control program stored therein. Furthermore, the control device contains a processor for executing the stored control program, whereby the control program executes the coating method according to the disclosure by controlling or querying the corresponding components of the coating installation.

Furthermore, in accordance with the prior art (e.g. DE 10 2021 108 563 A1), the coating installation according to the disclosure also has a second coating robot (e.g. painting robot) for applying the coating agent to the component along the neighboring track adjacent to the reference track within the coating area on the component.

The control device is designed in such a way that it uses the optical sensor to detect defects on the component in order to avoid incorrect detection of the spatial course of the reference track and a correspondingly incorrect determination of the spatial course of the neighboring track. The control device can then carry out the steps described above for the coating method according to the disclosure, so that reference can be made to the above description.

Other claimed further embodiments of the disclosure are characterized in the dependent claims or are explained in more detail below together with the description of the embodiments of the disclosure with reference to the figures.

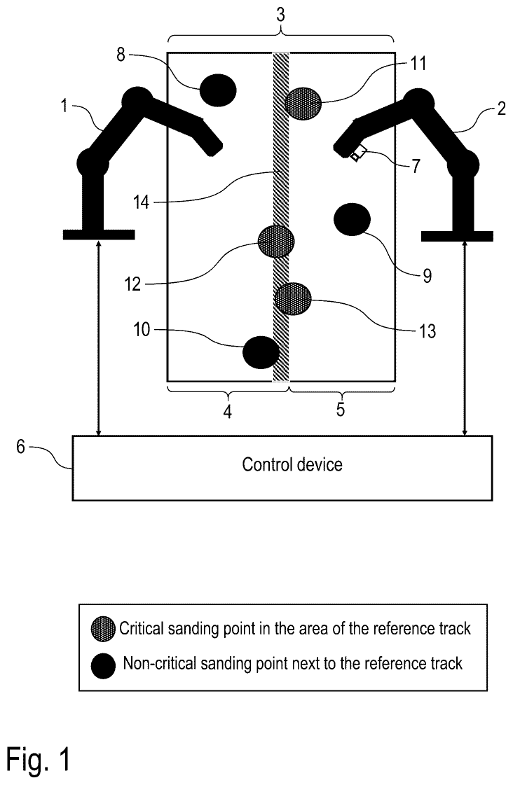

FIG. 1 shows a highly simplified schematic representation of a painting installation according to the disclosure for carrying out the painting process according to the disclosure.

The painting installation comprises two painting robots 1, 2 that can cooperate with each other to jointly paint a coating area 3, as is known, for example, from DE 10 2021 108 563 A1.

The coating area 3 can be, for example, a roof surface of a motor vehicle body, to name just one example. The coating area 3 is divided into two partial areas 4, 5, which are adjacent to each other, whereby the first partial area 4 is painted by the painting robot 1, while the other partial area 5 is painted by the painting robot 2. For example, the first partial area 4 may be the left half of the roof of the motor vehicle body, while the second partial area 5 is the right half of the roof of the motor vehicle body.

In addition, the painting installation comprises a control device 6, which controls the two painting robots 1, 2 and also interrogates a camera 7, which is guided over the coating area 3 by the painting robot 2, as will be described in detail.

In addition, the drawing shows several defects 8-13, which are sanding marks resulting from a previous repair of paint defects on a paint layer on the coating area 3.

The defects 8-13 may affect the subsequent application of coating agent tracks to the coating area 3, as described below.

The painting robot 1 first applies a reference track 14 (“master track”) to the coating area 3 at the boundary between the two partial areas 4, 5. The spatial course of the reference track 14 is then measured by the camera 7, which is guided over the coating area 3 by the painting robot 2.

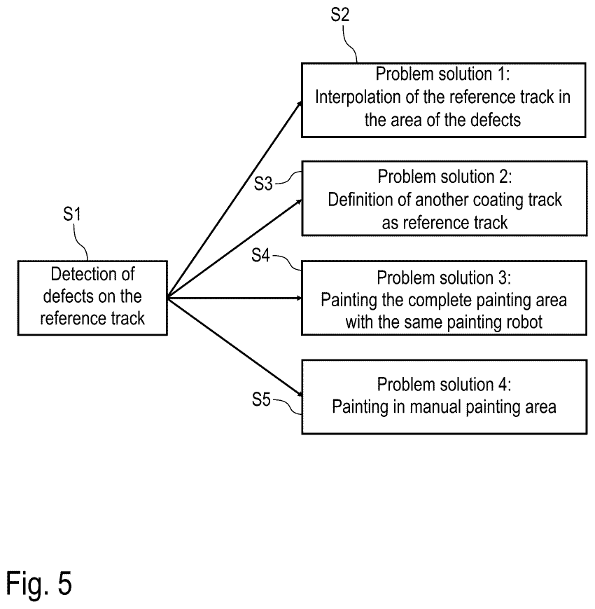

The measurement of the spatial course of the reference track 14 by the camera 7 can be impaired by the defects 8-13. The defects 8-10 are relatively uncritical defects, as they are not located directly on the reference track 14 or on the subsequent measurement track. The defects 11-13, on the other hand, are critical for the measurement of the spatial course of the reference track 14 by the camera 7, as the reflection behavior of the surface in the area of the critical defects 11-13 is changed, so that the camera 7 cannot determine the lateral edge of the reference track 14 accurately. FIG. 5 shows various problem-solving measures for this case, which will be described in detail later.

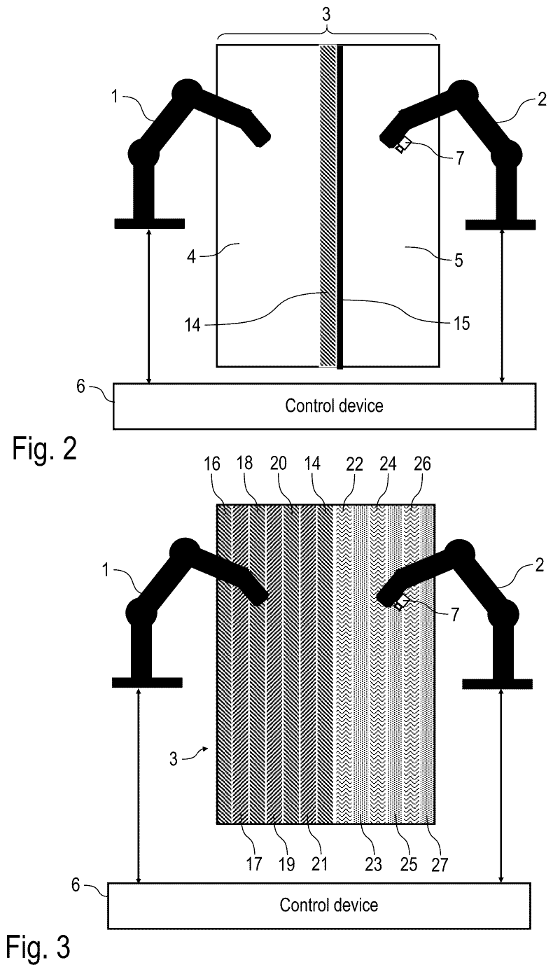

FIG. 2 shows the illustration from FIG. 1 with an additional measuring track 15 next to the actual reference track 14. To measure the spatial course of the reference track 14, the painting robot 2 moves the camera 7 along the measuring track 15 in such a way that the spatial course of the reference strip 14 can be measured.

FIG. 3 shows the illustration from FIGS. 1 and 2, whereby the coating area 3 is continuously coated with numerous parallel paint tracks 16-27, which run alongside the reference track 14. The paint tracks 16-21 are applied by the first coating robot 1, while the paint tracks 22-27 are applied by the coating robot 2.

In the finished state, the paint tracks 16-27 together with the previously applied reference track 14 then form a continuous paint layer on the coating area 3.

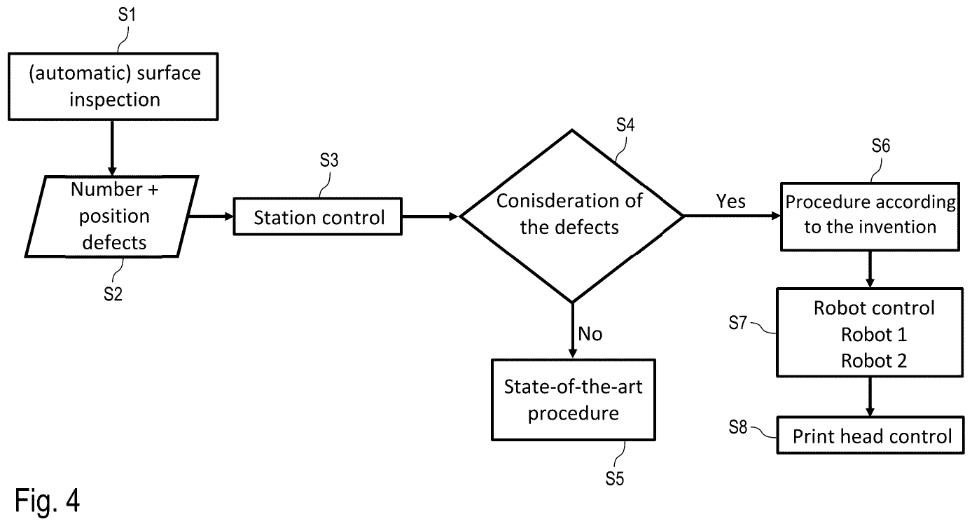

The flow chart shown in FIG. 4 is described below.

In the first step S1, the surface is inspected automatically, if necessary, using an optical system (e.g. strip light projector, camera).

In step S2, the defects are recorded in terms of their number, size and position.

This data is then transferred to a station control of the painting installation in step S3. The size of the sanding points is calculated depending on whether the defects are sanded manually or robotically. For the sake of simplicity, the term defects is also used below for sanding points.

In step S4, a decision is then made as to whether the defects should be taken into account.

If this is not the case, the procedure continues in a step S5 according to the prior art, i.e. no problem-solving measures are taken to compensate for a possibly incorrect measurement of the spatial course of the reference track.

Otherwise, the procedure according to the disclosure, which has already been described above and is explained again below with reference to FIG. 5, is carried out in step S6.

In step S7, the control device then controls the two painting robots and in step S8, the print head is also controlled accordingly.

FIG. 5 now shows possible problem-solving measures if critical defects along the reference track are identified in step S1.

A first option in step S2 is to interpolate the spatial course of the reference track in the area of the defects.

Another way of solving the problem in step S3 is to define a different coating track as a reference track that is not affected by defects. The intended reference track is then discarded as an orientation aid. Instead, a different coating track is applied and used as a guide.

Another option in step S4 is to paint the entire painting surface with the same painting robot. This halves the performance of the painting installation, which leads to a correspondingly longer cycle time. However, this is still better than a complete failure of the painting installation.

Another way of solving the problem in step S5 is to carry out the painting in a manual painting area (e.g. repair area).

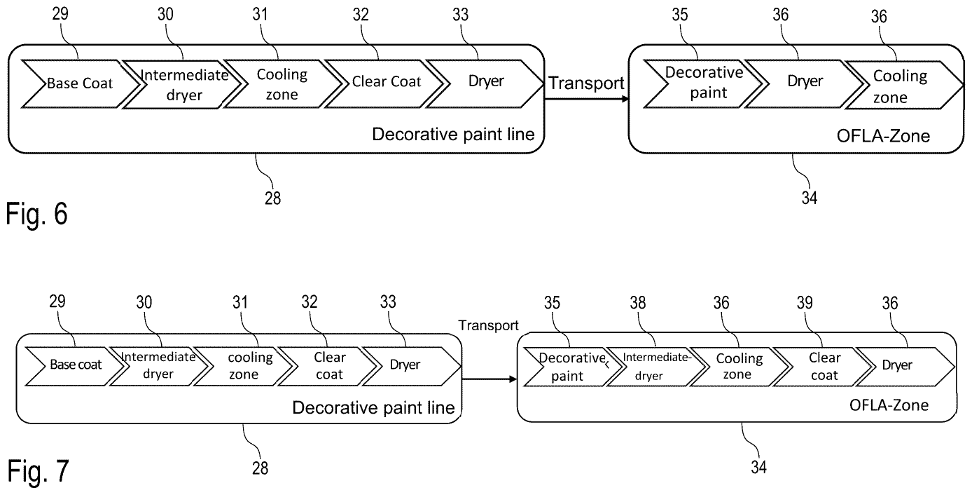

The embodiment example shown in FIG. 6 is described below.

Thus, FIG. 6 first shows a top coat line 28 for applying a top coat, the top coat line 28 having a base coat station 29, an intermediate dryer 30, a cooling zone 31, a clearcoat station 32 and a dryer 33.

The vehicle bodies to be painted are then conveyed from the top coat line 28 to an overspray-free painting zone 34, in which a print head is used as the application device. The overspray-free painting zone 34 (so-called OFLA zone) contains a decorative paint station 35, a dryer 36 and a cooling zone 37.

The process according to the disclosure described above is then carried out in the overspray-free painting zone 34. This is advantageous because the print heads used there as application devices emit a narrowly defined and selective jet of coating agent and therefore have only a small positioning tolerance.

FIG. 7 shows a modification of FIG. 6, so that reference is made to the above description to avoid repetition, whereby the same reference signs are used for corresponding details.

A special feature here is that the overspray-free painting zone 34 also contains an intermediate dryer 38 and a clear coat station 39.

A significant advantage of the disclosed technology is that a high painting quality can be maintained even in the case of defects (e.g. sanding marks).

In addition, the production flow can also be maintained in the event of defects, for example by having a painting robot paint the surface area that should actually be painted by another painting robot. Precise measurement of the reference track is only essential with cooperating painting robots.

1-16. (canceled)

17. A coating method for coating a component with a coating agent, comprising:
applying the coating agent to the component along a reference track within a coating area on the component;
detecting a spatial course of the reference track applied to the component;
determining the spatial course of at least one neighboring track adjacent to the reference track as a function of the determined spatial course of the reference track;
applying the coating agent to the component along the at least one neighboring track within the coating area on the component; and
determining defects on the component to avoid incorrect detection of the spatial course of the reference track and a correspondingly incorrect determination of the spatial course of the at least one neighboring track.

18. A coating method according to claim 17, further comprising the following step in response to the detection of at least one defect along the reference track:
interpolating the spatial course of the reference track in the region of the defects along the reference track when determining the spatial course of the reference track.

19. A coating method according to claim 17, further comprising measuring the spatial position of measuring points along the reference track and considering only those measuring points when determining the spatial course of the reference track that lie outside the defects.

20. A coating method according to claim 17, further comprising defining another coating track as the reference track in response to detecting at least one defect along the reference track.

21. A coating method according to claim 17, wherein a first partial area of the coating area is coated by a first coating robot, and a second partial area of the coating area is coated by a second coating robot, if no defects are detected along the reference track.

22. A coating method according to claim 21, further comprising the following step in response to the detection of at least one defect along the reference track: application also of the second partial area of the coating area by the first coating robot, so that the complete coating area is coated by the first coating robot.

23. A coating method according to claim 17, further comprising the following step in response to detecting at least one defect along the reference track: transfer to a manual painting area.

24. A coating method according to claim 23, wherein when at least one defect is detected along the reference track, the transfer to a manual coating area only takes place if at least one of the following conditions is also fulfilled:
a) the number of defects along the reference track exceeds a certain maximum value,
b) the size of the defects along the reference track exceeds a certain maximum size,
c) the spatial position of the defects along the reference track is critical.

25. A coating method according to claim 17, wherein the spatial position of the defects on the component is determined when determining the defects along the reference track, and the size of the defects along the reference track is determined when determining the defects, and when determining the defects along the reference track, only those defects are taken into account which have at least a certain minimum size.

26. A coating method according to claim 17, further comprising at least one of the following steps prior to the application of the coating agent:
a) applying a paint layer to the component,
b) determining paint defects in the applied paint layer,
c) sanding the paint layer at the paint defects so that sanding points are formed, whereby the sanding points form the defects.

27. A coating method according to claim 26, wherein
a) the spatial position of the sanding points on the component is determined when sanding the component surface,
b) the spatial position of the sanding points on the component is stored, and
c) the stored spatial positions of the sanding points are evaluated in order to determine the spatial position of the missing points along the reference track.

28. A coating method according to claim 17, wherein the spatial course of the reference track applied to the component and/or the defects is detected by means of an image processing system with at least one optical sensor.

29. A coating method according to claim 28, wherein the optical sensor is attached to a coating robot and is moved over the component by the coating robot.

30. A coating method according to claim 28, wherein the optical sensor is mounted in a fixed position.

31. A coating method according to claim 28, wherein the fixed optical sensor is part of a higher-level surface inspection or defect detection system.

32. A coating method according to claim 29, wherein
a) the reference track is applied by a first coating robot,
b) the neighboring track is applied by a second coating robot, and
c) the optical sensor is attached to the first coating robot and/or to the second coating robot and is moved by the latter over the surface of the component to be coated.

33. A coating method according to claim 29, wherein
a) the optical sensor is moved along a measuring track over the surface of the component to be coated in order to detect the spatial course of the reference track, and
b) the measuring track runs next to the reference track and essentially parallel to the reference track.

34. A coating method according to claim 17, wherein
a) the coating agent is a paint, and
b) the component to be coated is a motor vehicle body component, and
c) the coating agent is applied by an essentially overspray-free print head.

35. A coating installation for coating a component with a coating agent, with
a) a first coating robot for applying the coating agent to the component along a reference track within a coating area on the component,
b) an optical sensor for detecting the spatial course of the reference track applied to the component,
c) a control unit for interrogating the optical sensor and for determining the spatial course of a neighboring track adjacent to the reference track as a function of the determined spatial course of the reference track, and
d) a second coating robot for applying the coating agent to the component along the neighboring track within the coating area on the component,
e) wherein the control unit processes information about defects on the component, in particular those defects under the reference track, in order to avoid an incorrect detection of the spatial course of the reference track and a correspondingly incorrect determination of the spatial course of the neighboring track, in particular according to the coating method according to claim 1.
